(19) United States
(12) Patent Application Publication
(10) Pub. No.: US 2006/0139457 A1
(43) Pub. Date: Jun. 29, 2006

(54) Digital camera equipped with burglarproof and surveillance functions

(76) Inventor: Yi-Chia Liao, Miao-Li Hsien (TW)

Correspondence Address: BIRCH STEWART KOLASCH & BIRCH, PO BOX 747, FALLS CHURCH, VA, 22040-0747, US

(21) Appl. No.: 11/023,443

(22) Filed: Dec. 29, 2004

(51) Int. Cl. H04N 5/225; H04N 9/04

(52) U.S. Cl. 348/207.99; 348/373

(57) ABSTRACT

A digital camera equipped with burglarproof and surveillance functions contains a burglarproof surveillance element. When the burglarproof surveillance element detects an object, the digital camera is activated to take pictures and store the pictures in a memory storage unit. A picture taking device is provided to take the pictures in a static fashion and present the pictures individually with a clear image.

### FIELD OF THE INVENTION

The present invention relates to a digital camera and particularly to a digital camera equipped with burglarproof and surveillance functions.

### BACKGROUND OF THE INVENTION

With arriving of the information age, the digital camera has become increasingly popular and has gradually replaced the conventional camera. In principle, there is no much difference between the digital camera and the conventional camera. They all focus light reflected from an object through a lens into the camera. The only difference is that the conventional camera forms an image on a film, however the digital camera forms an image on a charge-coupled device (CCD). CCD transforms the light passing through the lens to charged signals of different intensity. And the signals are converted to digital data that are stored as files readable by computers.

As the digital camera has rich functions and is more convenient, it gradually replaces the conventional camera. The picture taken by the digital camera is a static image. It is a still image presented individually. The image and picture is clear. A great added value for the digital camera may be created if it can be adapted for use in burglarproof function.

### SUMMARY OF THE INVENTION

Therefore the primary object of the invention is to provide a digital camera equipped with burglarproof and surveillance functions that includes a burglarproof surveillance element in the digital camera to take pictures for preventing burglars.

Another object of the invention is to provide a digital camera equipped with burglarproof and surveillance functions that can take pictures one by one in a static fashion to produce clear and high quality images.

The digital camera according to the invention includes a picture taking device and a host. The digital camera also has a burglarproof surveillance element which is installed on a front side of the picture taking device to detect and take pictures to provide burglarproof functions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is an exploded view of the present invention.

FIG. 3 is a control circuit block diagram of the picture taking device of the invention.

FIG. 4 is a control circuit block diagram of the host of the invention.

### DETAILED DESCRIPTION OF THE PREFERRED EMBODIMENT

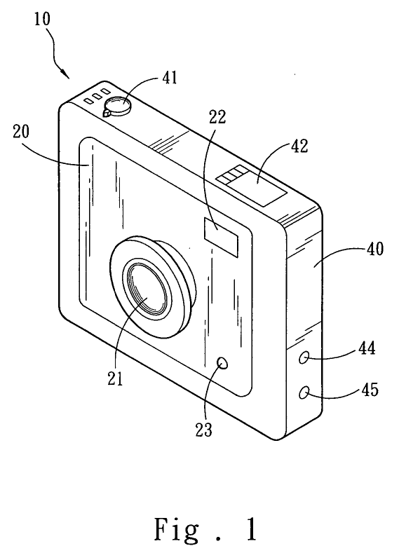

Please refer to FIG. 1 for the perspective view of the invention. A digital camera 10 according to the invention includes a picture taking device 20 and a host 40. The picture taking device 20 includes a lens 21 which consists of a CCD sensor (charged coupled device) and a lens that may be selectively a telephoto lens, a standard lens or a wide-angle lens. It adopts photosensitive electronic principle to capture images. Namely, the sensors receive light and generate electrons at a quantity proportional to the intensity of the light. The picture taking device 20 includes an optical viewfinder 22 to enable users to see the images to be taken through the lens 21, and at least one burglarproof sensor 23 to automatically detect signals of human body temperature or movement. The burglarproof sensor 23 may be an electronic human sensor or an infrared sensor. When an object is detected, the lens 21 is activated, and image data may be captured through the picture taking function of the digital camera 10.

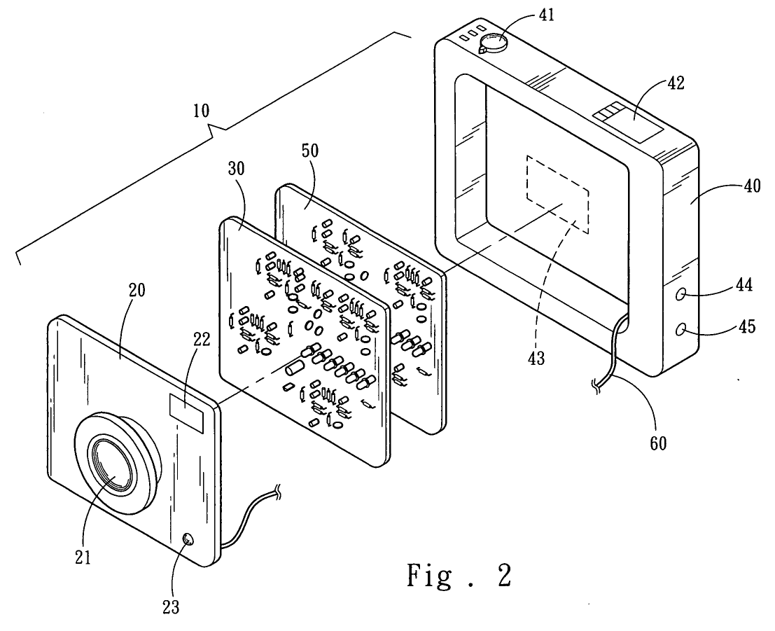

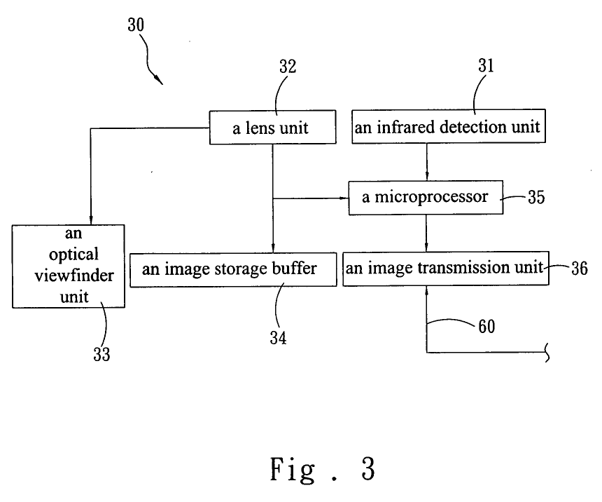

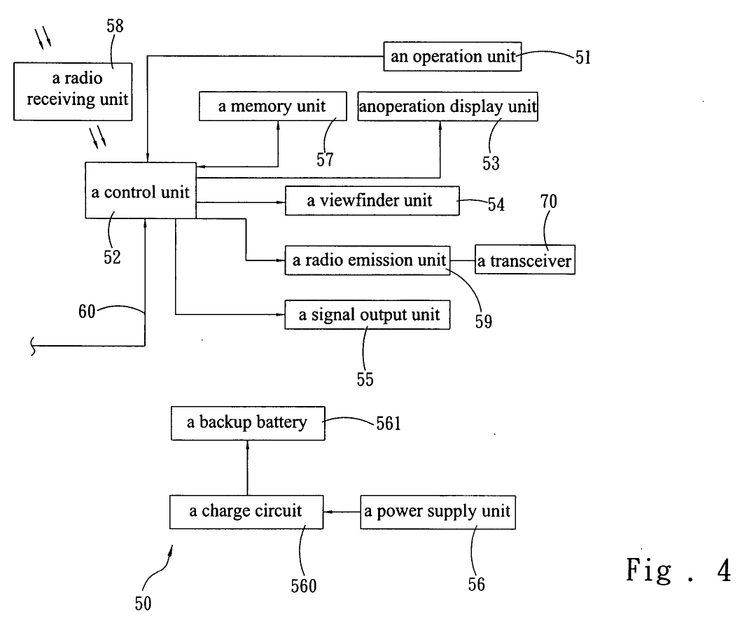

Referring to FIGS. 2 and 3, the picture taking device 20 contains a first control circuit 30 which includes an infrared detection unit 31 to receive signals from the burglarproof sensor 23 and emit signals to a microprocessor 35 which issues signals to an image transmission unit 36; a lens unit 32 to receive the signals from the lens 21 and transfer the signals to the microprocessor 35 and an image storage buffer 34; an optical viewfinder unit 33 to display the signals of the lens unit 32; the image storage buffer 34 to temporarily store the signals taken by the lens unit 32; the microprocessor 35 to receive the signals from the infrared detection unit 31 and the lens unit 32, and issue signals to the image transmission unit 36; the image transmission unit 36 to receive the signals from the microprocessor 35 and transfer the signals in the image storage buffer 34 to a memory unit 57 in the host 40 for storing (also referring to FIG. 4).

Referring to FIGS. 2 and 3 again, the host 40 is connected to the picture taking device 20 through a transmission line 60 to transmit the images taken by the picture taking device 20 to the host 40. The host 40 includes a manual shutter button 41 which functions like the shutter release of the digital camera 10 for activating the picture taking device 20 to take pictures and has different operation modes for selection, an operation display window 42 to display the operation mode of the manual shutter button 41, a LCD viewing window 43 to enable users to directly see the picture taken, at least one set of video/audio output jack 44 for connecting to a TV set, and a video/audio input jack 45 for connecting to a signal source. The image of the signal source may be seen through the LCD viewing window 43.

Referring to FIG. 4, the host 40 contains a second control circuit 50 which includes an operation unit 51 connecting to the manual shutter button 41 and issuing operation signals to a control unit 52, a operation display unit 53 to receive the operation signals from the control unit 52 and display signal conditions on the operation display window 42, a viewfinder unit 54 to receive signals from the control unit 52 and transfer the signals to the LCD viewing window 43 to allow users to directly see the pictures taken, a signal output unit 55 to receive the signals from the control unit 52 and transfer the signals to the TV set, a power supply unit 56 to connect to a charge circuit 560 and a backup battery 561 to provide electric power needed, a memory unit 57 to store the signals conditions of the control unit 52, and receive the signals temporarily stored in the image storage buffer 34, a radio receiving unit 58 to receive external remote control signals and transmit the signals to the control unit 52, and a radio emission unit 59 to receive the signals from the control unit 52 and emit radio signals to a transceiver 70 such as a USB transceiver box or the like. Images may be transmitted to a computer through USB signal transmission. The control unit 52 receives signals from the image transmission unit 36 and the radio remote control signals from the radio emission unit 59, and transmits signals to various units.

The digital camera 10 thus constructed has burglarproof and surveillance functions. For instance, the digital camera 10 may be placed on a location in the house where intruders are likely to enter, and at least one burglarproof sensor 23 is deployed to detect the intrusion and take pictures. The burglarproof sensor 23 may have different detection angles for selection (such as 15, 30, 60, 90, 120 degrees) to enhance the surveillance effectiveness. Moreover, the second control circuit 50 of the host 40 includes the radio receiving unit 58 or radio emission unit 59. The radio receiving unit 58 can receive external remote signals to activate the control unit 52 in the host 40. When the control unit 52 receives the signals of the infrared detection unit 31 that indicate the occurrence of invasion of intruders, the signals of the picture being taken will be immediately emitted by radio transmission. Thus, even if the digital camera 10 is being discovered and destroyed by the intruder, the burglarproof function of the invention may be maintained intact.

It is to be noted that the invention adopts the static picture taking approach to achieve the burglarproof and surveillance functions. The pictures are taken individually in a static fashion same as the ordinary digital camera. It is different from the dynamic picture taken by the conventional surveillance burglarproof devices. As the dynamic picture taking often results in fuzzy images and difficult to recognize, the pictures taken by the invention are stored in the memory. The resolution of the pictures may be adjusted as desired to get clearer pictures for recognition. In addition, the image may be transmitted to a TV set or a computer through the transceiver 70 to further enhance the practicality.

What is claimed is:

1. A digital camera equipped with burglarproof and surveillance functions comprising a picture taking device and a host;
wherein the digital camera contains a burglarproof surveillance element which is installed on a front side of the picture taking device.

2. The digital camera equipped with burglarproof and surveillance functions of claim 1, wherein the burglarproof surveillance element is an electronic human sensor.

3. The digital camera equipped with burglarproof and surveillance functions of claim 1, wherein the burglarproof surveillance element is an infrared sensor.

4. The digital camera equipped with burglarproof and surveillance functions of claim 1, wherein the picture taking device has a first control circuit which includes an infrared detection unit, a lens unit, an optical viewfinder unit, an image storage buffer, a microprocessor, and an image transmission unit;
wherein the infrared detection unit generates signals which are transmitted to the microprocessor, the microprocessor issues signals to the image transmission unit, the lens unit generates signals which are transmitted to the microprocessor and the image storage buffer, the optical viewfinder unit displays the signals of the lens unit, the image storage buffer stores temporarily the signals captured by the lens unit, the microprocessor receives the signals from the infrared detection unit and the lens unit and transfers the signals to the image transmission unit, and the image transmission unit receives the signals from the microprocessor and transmits the signals to the image storage buffer;
wherein the host contains a second control circuit which includes an operation unit, an operation display unit, a viewing unit, a signal output unit, a power supply unit, a memory storage unit, a radio receiving unit, a radio emission unit and a control unit;
wherein the operation unit generates operation signals which are transferred to the control unit; the operation display unit receives the operation signals from the control unit, the viewing unit receives signals from the control unit, the signal output unit receives the signals from the control unit, the power supply unit is connected to a charge circuit and a backup battery to supply electric power required, the memory storage unit stores signal conditions of the control unit and receives the signals from the image storage buffer and stores the signals, the radio receiving unit receives the signals from the infrared detection unit and transfers the signals to the control unit, the radio emission unit receives the signals from the control unit and emits the signals by radio, and the control unit receives the signals from the image transmission unit and remote detection radio signals emitted by the radio emission unit, and transmits the signals to each unit.

5. The digital camera equipped with burglarproof and surveillance functions of claim 5, wherein the radio emission unit is connected to a transceiver.

6. The digital camera equipped with burglarproof and surveillance functions of claim 1, wherein the picture taking device includes an optical viewing window.

7. The digital camera equipped with burglarproof and surveillance functions of claim 1, wherein the host further includes a manual shutter button, an operation display window, a LCD viewing window, a video/audio output jack and, a video/audio input jack.
